(19) United States
(12) Patent Application Publication
(10) Pub. No.: US 2026/0064700 A1
(43) Pub. Date: Mar. 5, 2026

(54) METHOD FOR CONTENT RECOMMENDATION, APPARATUS, DEVICE, MEDIUM AND PROGRAM PRODUCT

(71) Applicant: Beijing Zitiao Network Technology Co., Ltd., Beijing (CN)

(72) Inventors: Xin Yang, Beijing (CN); Quan Meng, Beijing (CN); Hongwei Kang, Beijing (CN); Yuzhou Wang, Beijing (CN); Ruidong Pan, Beijing (CN); Qi Chen, Beijing (CN)

(21) Appl. No.: 19/316,582

(22) Filed: Sep. 2, 2025

(30) Foreign Application Priority Data
Sep. 2, 2024 (WO) PCT/CN2024/116423

(51) Int. Cl. G06F 16/2457

(52) U.S. Cl. CPC G06F 16/24578

(57) ABSTRACT

Provided in the disclosure a method for content recommendation, comprising: determining a plurality of sets of candidate recommended content from a content library utilizing a plurality of content screening strategies, where the plurality of content screening strategies are based on different content ranking criteria; determining, using a trained machine learning model, a recommendation score of each piece of candidate recommended content in the plurality of sets of candidate recommended content relative to a target user based on user reference information of the target user and content reference information of the plurality of sets of candidate recommended content; and determining a set of target recommended content from the plurality of sets of candidate recommended content based on the recommendation score corresponding to each piece of candidate recommended content in the plurality of sets of candidate recommended content for providing to the target user.

### CROSS-REFERENCE

This application claims priority to PCT Application No. PCT/CN2024/116423, entitled “METHOD FOR CONTENT RECOMMENDATION, APPARATUS, DEVICE, MEDIUM AND PROGRAM PRODUCT,” filed Sep. 2, 2024, the entire contents of which are incorporated herein by reference.

### FIELD

Example embodiments of the present disclosure generally relate to the field of computer technologies, and in particular to a method, an apparatus, a device, a computer-readable storage medium, and a computer program product for content recommendation.

### BACKGROUND

The Internet offers access to a wide variety of resources. For example, various applications, commodities, audio and video content, and the like may be accessed through the Internet. In addition, content delivery and service promotion through the Internet become a common application for information propagation. Content recommendation systems support presenting recommended content or services to users, allowing users to browse and obtain corresponding services and the like as needed. How to provide users with recommended content that better meets expectations and is with higher quality is a problem in recommendation scenarios.

### SUMMARY

In a first aspect of the present disclosure, a method for content recommendation is provided. The method comprises the following steps: determining a plurality of sets of candidate recommended content from a content library by utilizing a plurality of content screening strategies, wherein the plurality of content screening strategies are based on different content ranking criteria; utilizing a trained machine learning model, and determining a recommendation score of each candidate recommended content in the plurality of sets of candidate recommended content relative to the target user based on the user reference information of the target user and the content reference information of the plurality of sets of candidate recommended content; and determining a set of target recommended content from the plurality of sets of candidate recommended content based on the recommendation score corresponding to each candidate recommended content in the plurality of sets of candidate recommended content for providing to the target user.

In a second aspect of the present disclosure, an apparatus for content recommendation is provided. The device comprises a candidate content determination module, a recommendation score determination module and a target content determination module, wherein the candidate content determination module is configured to determine a plurality of sets of candidate recommended content from a content library by utilizing a plurality of content screening strategies, and the plurality of content screening strategies are based on different content ranking criteria; the recommendation score determination module is configured to determine a recommendation score of each candidate recommended content in the plurality of sets of candidate recommended content relative to the target user based on the user reference information of the target user and the content reference information of the plurality of sets of candidate recommended content by using the trained machine learning model; and the target content determination module is configured to determine a set of target recommended content from the plurality of sets of candidate recommended content based on the recommendation score corresponding to each candidate recommended content in the plurality of sets of candidate recommended content for providing to the target user.

In a third aspect of the present disclosure, an electronic device is provided. The apparatus includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The medium stores a computer program, and when the computer program is executed by the processor, the method in the first aspect is implemented.

In a fifth aspect of the present disclosure, a computer program product is provided. The computer program product is tangibly stored in a computer storage medium and includes computer-executable instructions that, when executed by a device, cause the device to perform the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2 illustrates a schematic diagram of an architecture for content recommendation according to some embodiments of the present disclosure;

FIG. 3 illustrates an example of a screening module utilizing a first content screening strategy according to some embodiments of the present disclosure;

FIG. 4 illustrates an example of a screening module utilizing a second content screening strategy according to some embodiments of the present disclosure;

FIG. 5 illustrates an example of a screening module utilizing a third content screening strategy according to some embodiments of the present disclosure;

FIG. 6 illustrates an example of training data for a ranking model for a user according to some embodiments of the present disclosure;

FIG. 7 illustrates an example of determining a recommendation score of each piece of candidate recommended content with respect to a target user by a trained machine learning model according to some embodiments of the present disclosure;

FIG. 8 illustrates a flowchart of a method for content recommendation according to some embodiments of the present disclosure;

FIG. 9 shows a block diagram of an apparatus for content recommendation according to some embodiments of the present disclosure; and

FIG. 10 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

It may be understood that the data involved in the technical solution (including but not limited to the data itself, the acquisition or use of the data) should follow the requirements of the corresponding laws and regulations and related regulations.

It may be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the authorization of the user is obtained.

For example, in response to receiving an active request from a user, prompt information is sent to the user to explicitly prompt the user that the requested operation will need to obtain and use personal information of the user, so that the user may autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative and does not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, increasing the depth of the network. Each layer of the neural network is connected in sequence such that the output of the previous layer is provided as an input to the next layer, where the input layer receives the input of the neural network, and the output of the output layer serves as the final output of the neural network. Each layer of the neural network includes one or more nodes (also referred to as processing nodes or neurons), each node processing input from the previous layer.

Generally, machine learning may generally include three phases, a training phase, a testing phase, and an application phase (also referred to as an inference phase). At the training phase, a given model may be trained using a large amount of training data, constantly updating the parameter values, until the model is able to obtain consistent inferences from the training data that satisfy the expected objectives. By training, the model may be considered to be able to learn from the training data, an association from input to output (also referred to as mapping of input to output). The parameter values of the trained model are determined. In the testing phase, the test input is applied to the trained model to test whether the model may provide the correct output, thereby determining the performance of the model. The testing phase may sometimes be fused in a training phase. In the application or inference phase, the trained model may be used to process the actual model input based on the parameter value obtained by training, to determine a corresponding model output.

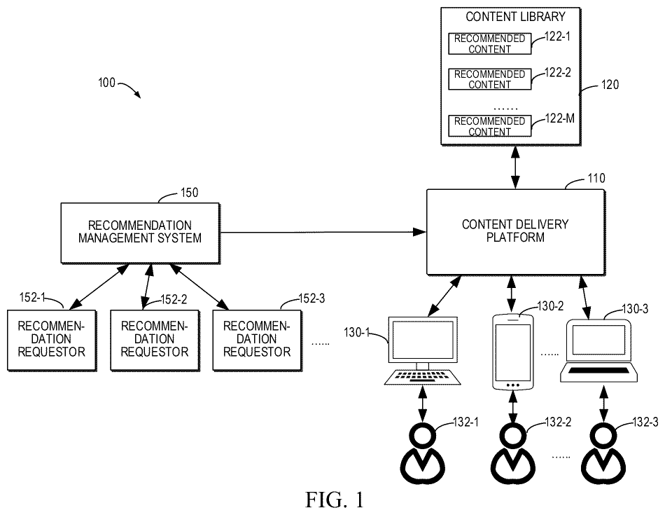

FIG. 1 illustrates a schematic diagram of an example environment 100 in which embodiments of the present disclosure may be implemented. One or more content providers may use a recommendation management system 150 to manage content to be placed on a content delivery platform 110. One or more client devices 130-1, 130-2, 130-3, etc. (collectively or individually referred to as client devices 130 for ease of discussion) are associated with the content delivery platform 110 and may access various content provided on the content delivery platform 110, e.g., based on respective users 132-1, 132-2, 132-3, etc. (collectively or individually as users 132 for ease of discussion). As an example, the content delivery platform 110 may be an application, a website, a web page, or other accessible platforms. The client device 130 may be installed with an application for accessing the content delivery platform 110, or access the content delivery platform 110 in a suitable manner.

The content delivery platform 110 may be configured to deliver one or more particular pieces of recommended content (e.g., provided or presented at the client device 130) related to one or more objects to the user group based on corresponding strategies. The recommended content to be delivered may include, for example, one or more pieces of recommended content 122-1, 122-2, . . . , 122-M (collectively or individually referred to as recommended content 122 for ease of discussion, which may be referred to as recommended content for short) in the content library 120 (also referred to as content database, database, recommended content library, etc.).

Examples of recommended objects may include, but are not limited to, applications, entity goods/services, virtual goods/services, digital content/entity content, and the like. Here, “recommended content” refers to content associated with a recommended object, which may be presented to a corresponding user group to achieve the purpose of recommending the corresponding object. Recommended content is sometimes also referred to as object-related material content, examples of which may include advertisements, including videos, images, graphic works, plain text content, and the like. Recommended content may include data sources uploaded and specified by the recommendation requester, or may be user-generated content (UGC) (note that the use of the user-generated content is authorized by the user), and so on.

Herein, a user group may include one or more user members, such as user 132. A user member may be any potential consumer of a service, such as a user, group, organization, entity, or the like. In some embodiments, the content delivery platform 110 may distribute the corresponding recommended content 122 to the user 130 based on a request from each of the recommendation requestors 152-1, 152-2, 152-3, etc. (collectively or individually as “recommendation requestors” 152).

In some embodiments, the service provider may also provide certain cost expenditure to the content delivery platform 110 based on the presentation of the recommended content and subsequent conversions. The conversion result for the recommended content may include viewing, clicking, downloading, paying for, adding to a shopping cart of the recommended content and the like, and the specific conversion behavior is related to the recommended object and the service provider.

In environment 100, the client device 130 may be any type of mobile terminal, fixed terminal, or portable terminal, including a mobile handset, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, gaming device, or any combination of the foregoing, including accessories and peripherals of these devices, or any combination thereof. In some embodiments, the client device 130 may also support any type of interface for a user (such as a “wearable” circuit, etc.).

In environment 100, the content delivery platform 110 and/or recommendation management system 150 may be, for example, various types of computing systems/servers capable of providing computing power, including, but not limited to, mainframes, edge computing nodes, computing devices in a cloud environment, and so forth. Although illustrated separately, one or more of the content delivery platforms 110 and/or the recommendation management system 150 may be combined.

It should be understood that the components and arrangements in the environment shown in FIG. 1 are merely examples, and that the computing system suitable for implementing the example embodiments described in this disclosure may include one or more different components, other components, and/or different arrangements. The number of elements shown in FIG. 1 is merely an example, and more or fewer number of elements may actually exist.

Conventionally, a set of candidate recommended content is usually recalled from a content library, and the set of candidate recommended content is roughly ranked. Then a set of target recommended content to be recommended to the user is determined from the set of candidate recommended content based on the rough ranking result. However, in a case that the number of pieces of recommended content in the content library is small, the traditional recommendation methods of simple recall, coarse ranking, and content determination have poor content recommendation effects. In a case that the number of pieces of recommended content in the content library is small, traditional cold start algorithm such as multiple delivery, collaborative filtering, data modeling, expert strategy and the like may also be used to implement content recommendation. However, the requirement of multiple delivery to the system capability is high, the small number of pieces of recommended content in the content library will result in limited recall results of collaborative filtering and cannot guarantee diversity, Data modeling has a relatively high requirement on the data volume, and the small number of pieces of recommended content will result in poor quality of data modeling. Expert strategy relies on manual experience and has high labor costs.

In view of this, according to an embodiment of the present disclosure, an improved solution for content recommendation is provided. According to the scheme, a plurality of sets of candidate recommended content are determined from a content library using a plurality of content screening strategies, and the plurality of content screening strategies are respectively based on different content ranking criteria. A recommendation score of each piece of candidate recommended content in the plurality of sets of candidate recommended content relative to a target user is determined based on user reference information of the target user and content reference information of the plurality of sets of candidate recommended content using a trained machine learning model. A set of target recommended content is determined from the plurality of sets of candidate recommended content based on the recommendation score corresponding to each piece of t candidate recommended content in the plurality of sets of candidate recommended content, so as to be provided to the target user.

Therefore, before the ranking and selection of recommended content are performed for a specific user, a plurality pieces of recommended content in the content library are selected according to the corresponding content screening strategy using various content ranking mechanisms. The model is then utilized to select candidate recommended content for the specific user. Not only may the accuracy and efficiency of content recommendation be improved, and not limited by the number of pieces of and type of recommended content included in the content library, but also the efficiency of performing content ranking and screening for a specific user may be improved.

Some example embodiments of the present disclosure will be described below with continued reference to the accompanying drawings.

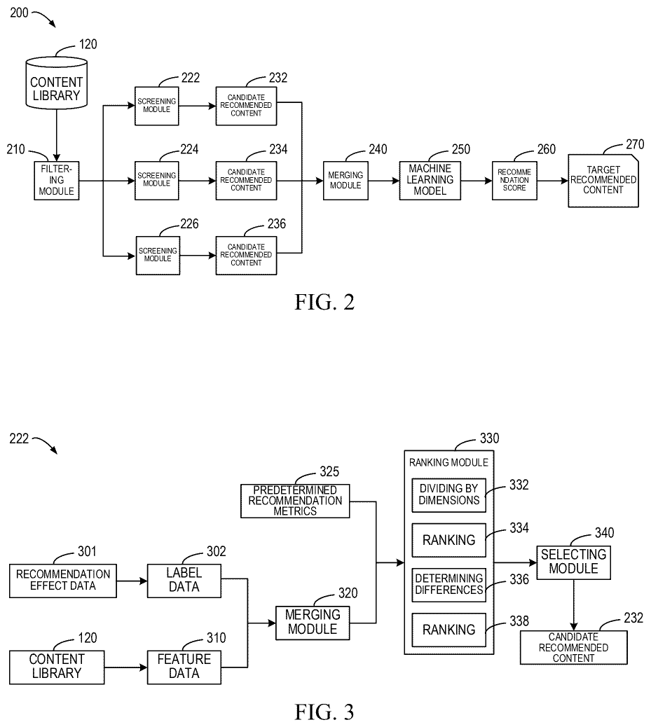

FIG. 2 shows a schematic diagram of an architecture 200 for content recommendation according to some embodiments of the present disclosure. For ease of description, an example in which the architecture 200 is implemented at the content delivery platform 110 is used for description. The architecture 200 will be described with reference to the environment 100 of FIG. 1. The architecture 200 at least involves a plurality of screening modules (e.g., screening module 222, screening module 224, and screening module 226) and a machine learning model 250. It may be understood that although only 3 screening modules are shown in the figure, in practice, any number of screening modules may be included.

The plurality of screening modules may determine the plurality of sets of candidate recommended content from the content library 120 using a plurality of content screening strategies. In some embodiments, in order to improve the accuracy of determining the plurality of sets of candidate recommended content, the architecture 200 may further involve a filtering module 210. The filtering module 210 may filter the content library 120 based on a predetermined filtering strategy. The predetermined filtering strategy may, for example, indicate filtering out the recommended content from a particular data source, filtering out the recommended content that includes particular content, filtering out the recommended content authored by a particular creator, and/or the like. For example, if the filtering strategy indicates that the recommended content including that food related content is filtered out, the filtering module 210 may filter the recommended content including food related content in the content library 120 through this filtering strategy, and the filtered content library 120 does not include food related recommended content. After the preliminary filtering is completed, the plurality of screening modules may determine the plurality of sets of candidate recommended content from the filtered content library 120 based on the corresponding content screening strategy.

Different screening modules may utilize different content screening strategies. For example, the screening module 222 may determine the first set of candidate recommended content 232 from the content library 120 using a first content filtering strategy (for example, a numerical value filtering strategy, which may be referred to as a numerical recall strategy). The screening module 224 may determine the second set of candidate recommended content 234 from the content library 120 using a second content screening strategy (for example, a high explosion screening strategy, which may also be referred to as a high explosion recall strategy). The filtering module 226 may determine the third set of candidate recommended content 236 from the content library 120 using a third content filtering strategy (for example, a similar filtering strategy, which may be referred to as a similar recall strategy).

Different content screening strategies may be based on different content ranking criteria. For each screening module, it may rank the recommended content in the content library 120 based on a content ranking criterion corresponding to the content screening strategy and select a set of candidate recommended content in the content library 120 based on the ranking result. It may be understood that different screening modules may rank the recommended content in the content library 120 based on different content ranking criteria. For example, each screening module may determine, based on a corresponding ranking result, a predetermined number of pieces of recommended content that is ranked at the top as a set of recommended content determined by the screening module. By selecting (also referred to as a recall) some recommended content determined to be with higher quality under the corresponding criteria from the content library according to different content ranking criteria, it is ensured that the recommended content that is more beneficial to each user may be selected.

After determining the plurality of sets of candidate recommended content, the content delivery platform 110 may determine, using the trained machine learning model 250 (sometimes referred to as a recall ranking model), a recommendation score 260 of each piece of candidate recommended content in the plurality of sets of candidate recommended content with respect to the target user (for example, any one or more users in the user 132). The machine learning model 250 may be deployed on the content delivery platform 110, or on other devices. The machine learning model 250 may be based on any suitable model structure including, but not limited to, a Transformer model, a convolutional neural network (CNN), a recurrent neural network (RNN), a deep neural network (DNN), or the like. In some embodiments, the machine learning model 250 may be based on a language model. The language model may have natural language processing capability (including but not limited to semantic analysis capability, question and answer capability, etc.) by learning from a large corpus of corpora. The machine learning model 250 may also be based on other suitable models. It should be noted that the machine learning model 250 may include one or more machine learning models, which is not limited in the present disclosure.

In some embodiments, to reduce the workload and improve the efficiency of the model, the architecture 200 may further involve a merging module 240. The merging module 240 may be deployed between the plurality of screening modules and the machine learning model 250. After the plurality of sets of candidate recommended content are determined, they may be directly provided to the merging module 240. The merging module 240 may merge, de-duplicate, and the like on the plurality of sets of candidate recommended content to obtain a merged candidate content set. The merging module 240 may provide the merged candidate content set to the machine learning model 250 to determine the recommendation score 260 of each piece of candidate recommended content with respect to the target user using the machine learning model 250.

For a specific manner of determining the recommendation score 260 using the machine learning model 250, in some embodiments, the content delivery platform 110 may obtain user reference information of the target user and content reference information of the plurality of sets of candidate recommended content. The user reference information may include behavior data of the user over a period of time, interaction data for the recommended content or other types of content, various types of available user attribute information, and other reference information deemed to be reference for determining recommended content suitable for provision. The content reference information of the recommended content may include an author of the candidate recommended content, a source, specific content contained (e.g., text, visual data, audio data, etc.), user interaction data on the candidate recommended content, and other reference information deemed to be reference for determining whether to be recommended to the user. It should be noted that the specific types and forms of the user reference information and the content reference information to be used by the machine learning model 250 are not limited in the embodiments of the present disclosure. Depending on specific application scenarios and requirements, the information for reference may be selected is very diverse, and different machine learning models may be configured to reference various types of information.

It may be understood that, if the architecture 200 relates to the merging module 240, the content delivery platform 110 may obtain the user reference information of the target user and the content reference information of each piece of candidate recommended content in the merged candidate content set. For ease of description, the following uses a plurality of sets of candidate recommended content as an example for description.

For example, the content delivery platform 110 may generate a prompt word input for the machine learning model 250 based on the user reference information of the target user and the content reference information of the plurality of sets of candidate recommended content. The content delivery platform 110 may determine, based on the user reference information of the target user and the content reference information of the plurality of sets of candidate recommended content, the recommendation score 260 of each piece of candidate recommended content in the plurality of sets of candidate recommended content by inputting the prompt word input to the machine learning model 250.

In some embodiments, the recommendation score may be defined as a metric value of one or more recommendation metrics of interest in the content recommendation. For example, the recommendation score may be based on a probability that the target user performs a specific conversion behavior (e.g., click, collect, comment, purchase, etc.) on the recommended content after a certain amount of recommended content is provided to the target user. The higher the probability that a particular conversion behavior occurs, the higher the recommendation score is determined. Alternatively, or additionally, the recommendation score may also be based on a metric of interest of the content delivery platform after a certain amount of recommended content is provided to the target user, a retention duration of the target user on the content delivery platform, the number of new users of the content recommendation platform, and the like. Specific manners of measuring the recommendation score are not specifically limited in the embodiments of the present disclosure. In general, the recommendation score may be used to measure the importance or effectiveness of the recommended content for a particular user.

The content delivery platform 110 may further determine a set of target recommended content 270 from the plurality of sets of candidate recommended content based on the recommendation score 260 corresponding to each piece of recommended content in the plurality of sets of candidate recommended content for providing to the target user. The content delivery platform 110 may determine a set of target recommended content 270 in any suitable manner.

In some embodiments, the content delivery platform 110 may obtain a threshold score, and compare the recommendation score 260 corresponding to each piece of recommended content in the plurality of sets of candidate recommended content with the threshold score. The content delivery platform 110 may determine a set of recommended content with corresponding recommendation scores 260 reaching the threshold score in the plurality of sets of candidate recommended content as a set of target recommended content 270.

Alternatively, or additionally, in some embodiments, the content delivery platform 110 may also rank all the pieces of candidate recommended content in the plurality of sets of candidate recommended content in descending order based on the recommendation score 260 corresponding to each piece of candidate recommended content (that is, the higher the ranking of the candidate recommended content is, the higher the recommendation score 260 corresponding to the candidate recommended content is). It may be understood that the plurality of sets of candidate recommended content correspond to one ranking result. For example, the content delivery platform 110 may determine a set of recommended content with a predetermined number of pieces of recommended content that are ranked higher in the ranking result as a set of target recommended content 270.

It should be noted that the set of target recommended content 270 is a plurality pieces of recommended content determined from all pieces of candidate recommended content included in the plurality of sets of candidate recommended content. For example, 3 sets of candidate recommended content may be included, and each set of candidate recommended content may include 100 pieces of recommended content, and the determined final set of target recommended content may include 50 pieces of recommended content, where there are 20 pieces of candidate recommended content from the first set, 15 pieces of candidate recommended content from the second set, and 15 pieces of candidate recommended content from the third set.

It may be understood that, if the architecture 200 involves the merging module 240, and the machine learning model 250 determines the recommendation scores 260 of the merged candidate content set output by the merging module 240, the content delivery platform 110 may directly determine a set of target recommended content 270 from the merged candidate content set based on the recommendation score 260, where the number of pieces of recommended content included in the set of target recommended content 270 may be less than or equal to the number of pieces of recommended content included in the merged candidate content set.

Regarding the specific manner of determining the plurality of sets of candidate recommended content from the content library 120 using the plurality of sets of content screening strategies, in some embodiments, the screening module 222 may determine at least one feature related to the predetermined recommendation metric for the screening module 222 using a first content screening strategy. The predetermined recommendation metric is a core service metric used to measure the effectiveness of a recommendation, which includes, but is not limited to, a retention duration of the user on the platform, an average number of new users per day, cost required for new users, a conversion rate of a specific conversion behavior, and the like. The at least one feature related to the predetermined recommendation metric may include, for example, a feature that is positively correlated with the core service metric, including but not limited to a number of user likes, a number of collects, a number of author fans, and the like.

For each feature of the at least one feature, the screening module 222 may rank the recommended content in the content library 120 based on the feature value of each piece of recommended content in the content library 120 for the feature (for example, rank the recommended content in the content library 120 in a descending order). Each piece of recommended content has a corresponding feature value for a plurality of features. For each piece of recommended content, the screening module 222 may directly obtain the feature value of the recommended content for the feature based on the recommended content. The screening module 222 may select a first set of candidate recommended content from the content library 120 based on the result of ranking for the at least one feature. For example, the screening module 222 may determine a predetermined number of pieces of candidate content that are ranked high (e.g., 100 pieces of candidate content ranked in top100 in the ranking) as the first set of candidate recommended content 232. For another example, the screening module 222 may further determine, a plurality pieces of candidate content with corresponding feature values reaching a threshold in the ranking as the first set of candidate recommended content 232.

FIG. 3 illustrates an example of a filtering module 222 that utilizes a first content filtering strategy according to some embodiments of the present disclosure. For example, the screening module 222 may include a merging module 320, a ranking module 330, and a selecting module 340. The screening module 222 may obtain the feature data 310 corresponding to the respective pieces of recommended content in the content library 120. For each piece of recommended content, the feature data 310 may indicate feature values of the recommended content for various features.

In some embodiments, part of recommended content in the content library 120 may be provided to the user in advance (it may be understood that the user may include multiple users, that is, the user may refer to a user set). The screening module 222 may obtain the recommendation effect data 301 of this part of recommended content. For example, the recommendation effect data 301 may indicate a platform to which the recommended content is delivered, feedback of the user to the recommended content after the recommended content is delivered (for example, a number of likes, an average duration of being browsed, a number of collects, a number of reposts, a number of comments, comment content, and the like), conversion data corresponding to the recommended content (for example, how many users are converted based on the recommended content), and the like.

For each piece of recommended content (which may also be referred to as delivered recommended content) provided to the user, the screening module 222 may determine, according to the recommendation effect data 301 corresponding to the recommended content, label data 302 corresponding to the recommended content. The label data 302 corresponding to each piece of recommended content may indicate a recommendation effect of the recommended content. The recommended content with the corresponding label data 302 that has been delivered may be referred to as annotated recommended content. For each piece of annotated recommended content, the merging module 320 may combine the feature data 310 corresponding to each piece of annotated recommended content and the corresponding label data 302. The merging result (i.e., the label data 302 plus the feature data 310) is provided to the ranking module 330 along with the pre-obtained predetermined recommendation metric 325.

In some embodiments, the screening module 222 may further determine, based on a merging result corresponding to each piece of annotated recommended content and a predetermined recommendation metric 325, at least one feature (that is, determine at least one feature related to the predetermined recommendation metric) that affects the recommendation effect. For example, if there are totally 10 features, and there are 3 features affecting the recommendation effect of the annotated recommended content (that is, the change of the feature value of the 3 features will affect more significantly the recommendation metric value corresponding to the recommended content), the 3 features may be determined as the features related to the predetermined recommendation metric. For example, the screening module 222 may provide the merging result of the feature data and the label data of each piece of annotated recommended content for the at least one feature to the ranking module 330.

In some embodiments, if the at least one feature related to the predetermined recommendation metric includes a plurality of features, the ranking module 330 may divide (332) the recommended content in the content library 120 into a plurality of content sub-libraries respectively corresponding to a plurality of dividing dimensions according to the plurality of predetermined dividing dimensions. For example, the recommended content in the content library 120 may be divided into a plurality of content sub-libraries corresponding to a plurality of dividing dimensions according to the plurality of dividing dimensions such as a source, content, and an author, and each content sub-library corresponds to one dividing dimension. The reason for dividing the content library by dimensions is that the content recommended in different dimensions is different, and the influence factors of the recommendation effects of the corresponding recommended content in different dimensions are also different.

For a given dividing dimension (which may be any one of the plurality of dividing dimensions) of the plurality of dividing dimensions, the ranking module 330 may determine, for each of the plurality of features, a metric value of the annotated recommended content under the predetermined recommendation metric, where the annotated recommended content is divided into the given dividing dimension and related to the feature. Specifically, the ranking module 330 may determine a plurality of feature values of a plurality pieces of annotated recommended content for the plurality of features respectively. For each feature, the ranking module 330 may rank the plurality pieces of annotated recommended content according to the feature values of the plurality pieces of annotated recommended content for the feature (334), and the ranking may be, for example, in a descending order. The ranking module 330 may determine the annotated recommended content related to the feature based on the ranking result. For example, the ranking module 330 may determine a predetermined number of pieces of annotated recommended content with higher rankings the ranking result as the annotated recommended content related to the feature.

For each feature, the ranking module 330 may determine the metric value of the annotated recommended content related to the feature under the predetermined recommendation metric based on the feature value of the annotated recommended content related to the feature for the feature. Taking a total of 1,000 pieces of annotated recommended content divided into dividing dimension A as an example, for feature A of the plurality of features, the ranking module 330 may determine the feature values of each of the 1,000 pieces of annotated recommended content for feature A, and rank the 1,000 pieces of annotated recommended content in a descending order based on the feature values corresponding to each of the 1,000 pieces of annotated recommended content. For example, the ranking module 330 may determine, for example, the 100 pieces of annotated recommended content in the top 100 of the ranking result as the 100 pieces of annotated recommended content related to feature A. The ranking module 330 may determine an average value of the feature values of the 100 pieces of annotated recommended content under the feature A, and determine the average value as the metric value(which may also be referred to as the metric value determined for feature A in the given dividing dimension) of the annotated recommended content under the predetermined metric, where the annotated recommended content is divided into the given dividing dimension and related to the feature A.

In this manner, the ranking module 330 may determine, for a given dividing dimension, a metric value (which may be referred to as a plurality of metric values respectively determined for the plurality of features) of the annotated recommended content under a predetermined recommendation metric, where the annotated recommended content is divided into the given dividing dimension and related to the plurality of features. For each feature of the plurality of features, the ranking module 330 may further determine a difference (which may be, for example, a difference between the metric value for the feature and a reference metric value) between the metric value determined for the feature and a reference metric value (which may be, for example, a market metric value corresponding to the core service indicator). The ranking module 330 may determine 336a difference between each of the plurality of metric values and the reference metric value in a similar manner.

The ranking module 330 may, for example, select a reference feature for a given dividing dimension from the plurality of features based on the differences (which may also be referred to as the differences corresponding to the plurality of features) corresponding to the plurality of metric values. The ranking module 330 may determine, for example, a feature corresponding to the largest difference (or smallest, which may be determined based on the setting) as the reference feature (that is, an optimal feature) for the given dividing dimension. For example, if the plurality of features include feature A, feature B, and feature C, the ranking module 330 may determine the respective differences (that is, determine respective differences corresponding to the three features) between the respective metric values of the three features and the reference metric value in the given dividing dimension. If the metric difference of feature A is greater than that of feature B and greater than that of feature C, the ranking module 330 may determine feature A as the reference feature for the given dividing dimension, and the reference feature is considered as the preferred feature in the specific dividing dimension. The preferred feature may significantly affect recommendation metric values for recommended content at the given dividing dimension. Of course, for a given dividing metric, more than one reference feature may also be selected.

The ranking module 330 may determine respective reference features for the plurality of dividing dimensions in a similar manner. It may be understood that different dividing dimensions may have respective reference features. The ranking module 330 may rank, for each dividing dimension of the plurality of dividing dimensions, the recommended content in the content sub-library corresponding to the dividing dimension based on the feature value (or a weighted feature value of the plurality of reference features) of the recommended content in the content sub-library (that is, the recommended content that is divided into the dividing dimension, including the recommended content that do not have corresponding label data, that is, have not been delivered) corresponding to the dividing dimension, and obtain the ranking result for the plurality of dividing dimensions. The ranking here may be, for example, in a descending order.

Therefore, reference features corresponding to each dividing dimension may be determined based on a small amount of annotated recommended content with label data. For each divided dimension, all the pieces of recommended content in the content library 120 (which may be recommended content without label data) that are divided into the dividing dimensions are ranked according to the feature values for the reference feature (e.g., in a descending order) to obtain the ranking result, hence obtain respective ranking results of the diving dimensions.

For each dividing dimension, the selecting module 340 may determine, based on the ranking result, a candidate recommended content subset corresponding to the dividing dimension. For example, the selecting module 340 may determine a predetermined number of pieces of recommended content in the top of the ranking result as the candidate recommended content subset corresponding to the divided dimension. The selecting module 340 may further determine the first set of candidate recommended content 232 based on a plurality of candidate recommended content subsets corresponding to the plurality of dividing dimensions. For example, for each dividing dimension, the selecting module 340 may determine the top 10000 pieces of recommended content in the ranking result as the candidate recommended content subset corresponding to the dividing dimension. If there are 3 dividing dimensions, the selecting module 340 may determine 3 candidate recommended content subsets, each candidate recommended content subset including 10000 pieces of recommended content. The selecting module 340 may combine and deduplicate the 3 candidate recommended content subsets to obtain the first set of candidate recommended content 232.

In some embodiments, for the filtering module 224 utilizing a second content filtering strategy, the filtering module 224 may determine a set of features associated with a reference user. A “reference user” (i.e., a high value user) may be determined in accordance with various suitable manners. In some embodiments, after providing the recommended content to the user, a metric value of the user on the metric of interest is determined. For example, if the retention duration of the user in the application is of interest, the retention duration may be used as a metric. If it is determined that the retention duration of one or more users meets expectations after being provided with recommended content (for example, the retention duration exceeds a threshold), then this or these users may be determined as reference users. Further, based on the feature values of the recommended content that has been provided to this or these reference users for each feature, features related to the reference user may be selected from a plurality of features. Features related to the reference user are considered features that may contribute to the metrics of interest (e.g., retention duration).

The screening module 224 may rank the recommended content in the content library 120 based on the feature values of each piece of recommended content in the content library 120 for a set of features and select a second set of candidate recommended content from the content library 120 based on the ranking result. Similarly, the ranking here may be in a descending order, and the screening module 224 may determine a predetermined number of pieces of recommended content that are ranked high as the second set of candidate recommended content.

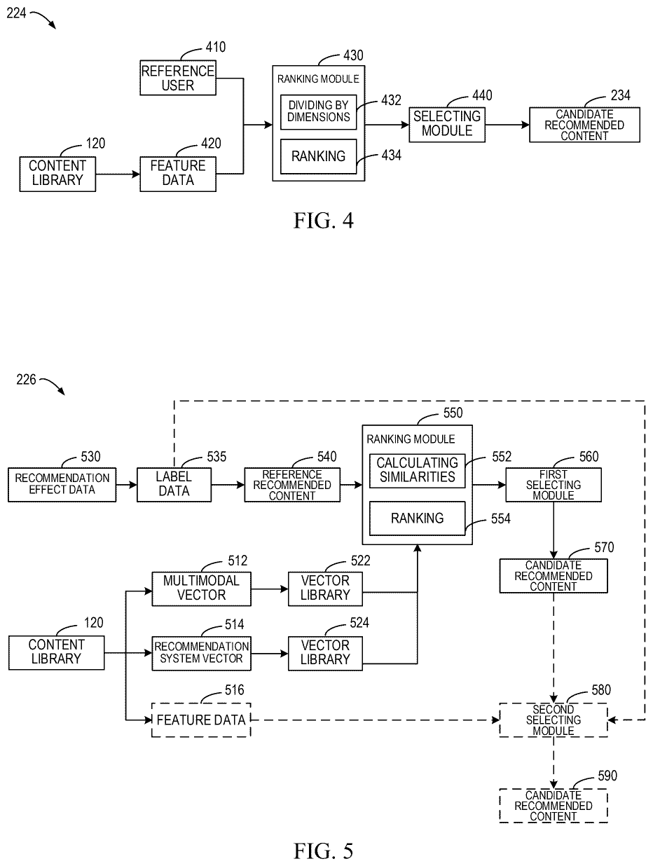

FIG. 4 illustrates an example of a filtering module 224 utilizing a second content filtering strategy according to some embodiments of the present disclosure. For example, the screening module 224 may include a ranking module 430 and a selecting module 440. The screening module 224 may obtain relevant information of the reference user 410, for example, may indicate a set of features associated with the reference user 410. The screening module 224 may also obtain the feature data 420 corresponding to the recommended content in the content library 120. For each piece of recommended content, the feature data 420 may indicate feature values of the recommended content for various features. Alternatively, or additionally, a set of features associated with the reference user 410 may also be determined by the screening module 224 based on feature data 420.

The ranking module 430 may divide (432) the recommended content in the content library 120 into a plurality of content sub-libraries respectively corresponding to the plurality of dividing dimensions (i.e., the recommended content included in each content sub-library is the recommended content divided into the given dividing dimension) according to a plurality of predetermined dividing dimensions. For example, the recommended content in the content library 120 may be divided into a plurality of content sub-libraries corresponding to a plurality of dividing dimensions according to the plurality of dividing dimensions such as a source, content, and an author, and each content sub-library corresponds to one dividing dimension. In some embodiments, the screening module 224 may further determine, for each dividing dimension, a plurality of reference users corresponding to the plurality of dividing dimensions and determine a plurality of sets of features respectively associated with the plurality of reference users. That is, different dividing dimensions may correspond to different reference users, and different reference users may be associated with different features.

For a given dividing dimension of the plurality of dividing dimensions, the ranking module 430 may rank the recommended content in the content sub-library corresponding to the given dividing dimension based on the feature values of the content sub-library corresponding to the given dividing dimension for the corresponding set of features (434). For each dividing dimension, each piece of recommended content in the content sub-library may be ranked in a descending order based on the feature value of each piece of recommended content in the corresponding content sub-library for a set of features. Specifically, if the set of features determined by the screening module 224 for a given dividing dimension may include a plurality of features, the ranking module 430 may determine weights respectively corresponding to the plurality of features. For each piece of recommended content in the content sub-library of a given dividing dimension, a feature value of the recommended content for a set of features may be determined based on respective feature values of the recommended content for the plurality of features and weights respectively corresponding to the plurality of features.

Taking a set of features including three features of feature A, feature B, and feature C as an example, the weights of the three features may be represented as a, b, and c, respectively. If the feature values of the recommended content A for the three features are x, y and z, respectively, the feature value of the recommended content A on the set of features is ax+by +cz. The ranking module 430 may similarly determine feature values of each piece of recommended content in a content sub-library corresponding to a given dividing dimension for a corresponding set of features and determine feature values of a content sub-library corresponding to each dividing dimension for a corresponding set of features.

Similarly, for each dividing dimension, the selecting module 440 may determine, based on the ranking result, a candidate recommended content subset corresponding to the dividing dimension. For example, the selecting module 440 may determine a predetermined number of pieces of recommended content in the top of the ranking result as the candidate recommended content subset corresponding to the divided dimension. The selecting module 440 may further determine the second set of candidate recommended content 234 based on the plurality of candidate recommended content subsets corresponding to the plurality of dividing dimensions.

In some embodiments, for the screening module 226 using a third content screening strategy, the screening module 226 may determine a plurality pieces of reference recommended content (which may also be referred to as seed recommended content). As mentioned above, some recommended content in the content library 120 may be provided to the user in advance. The screening module may determine, based on this part of recommended content, some recommended content with higher corresponding recommendation effects, and determine the recommended content as the reference recommended content. The screening module 226 may also obtain some reference recommended content manually entered by the relevant professional. That is, the reference recommended content may be determined by the screening module 226, or manually entered.

For each of the plurality pieces of reference recommended content, the screening module 226 may rank the recommended content in the content library 120 based on a similarity between each piece of recommended content in the content library 120 and the reference recommended content (for example, rank the recommended content in a descending order based on the similarity). The screening module 226 may, in turn, select a third set of candidate recommended content from the content library 120 based on the results of the ranking with respect to the plurality pieces of reference recommended content. Similarly, the ranking here may be in a descending order, and the screening module 226 may determine a predetermined number of pieces of recommended content ranked in the top and as a third set of candidate recommended content.

FIG. 5 illustrates an example of a filtering module 226 that utilizes a third content filtering strategy according to some embodiments of the present disclosure. For example, the screening module 226 may include a ranking module 550 and a first selecting module 560. The screening module 226 may determine a vector (for example, a multimodal vector 512 and a recommendation system vector 514) corresponding to the recommended content in the content library 120. The screening module 226 may further obtain feature data 516 of the recommended content. For example, the screening module 226 may determine the multimodal vector 512 of the recommended content based on the specific content of the recommended content (for example, image, video, text, audio, etc. included therein). For example, the screening module 226 may determine the recommendation system vector 514 of the recommended content based on the specific content of the recommended content and the user behavior corresponding to the recommended content. The screening module 226 may store the vector into a corresponding vector library. It may be understood that different types of vectors are stored to different vector libraries. For example, the multi-modal vector 512 is stored to the vector library 522 (e.g., a database, a data table, etc.), and the recommendation system vector 514 is stored to the vector library 524 (e.g., a search engine).

In some embodiments, the screening module 226 may further determine the label data 535 of the recommended content that has been delivered based on the recommendation effect data 530 of the recommended content that has been delivered in the content library 120. For example, the screening module 226 may determine a set of reference recommended content 540 based on the label data 535 of the recommended content that has been delivered. Alternatively, or additionally, the screening module 226 may also obtain a set of reference recommended content 540 manually entered. The screening module 226 may provide all the determined or obtained reference recommended content 540 to the ranking module 550.

For a specific manner of determining the similarity between each piece of recommended content and the reference recommended content 540, in some embodiments, the ranking module 550 may determine a reference vector for each piece of reference recommended content 540 and obtain a vector for each piece of recommended content from the vector library. The ranking module 550 may determine 552a similarity between the reference vector and the vector, and determine the similarity as the similarity between the reference recommended content and the recommended content. For example, the ranking module 550 may determine the similarity between the vectors by calculating the cosine similarity between the vectors. It may be understood that the screening module 226 may also determine the similarity between the reference recommended content and the recommended content in any other suitable manner, which is not limited in the present disclosure.

For example, referring to FIG. 5, the ranking module 550 may obtain a multimodal vector 512 corresponding to each piece of recommended content from the vector library 522. For example, the ranking module 550 may determine the reference multimodal vector of each piece of reference recommended content 540 based on the specific content of the reference recommended content 540. For each piece of reference recommended content 540, the ranking module 550 may determine a similarity between the reference multimodal vector of the reference recommended content 540 and the multimodal vector 512 of each piece of recommended content. The ranking module 550 may rank the plurality of recommended content based on the similarity corresponding to each piece of recommended content (554), for example, in a descending order.

The selecting module 560 may determine, based on the ranking result, a plurality pieces of recommended content with the similarities meets the requirement (for example, a predetermined number of pieces of recommended content in the top of the ranking result, or a plurality pieces of recommended content with similarities greater than a threshold), and determine a set of candidate recommended content 570 based on the plurality pieces of recommended content (that is, the set of candidate recommended content 570 may include the plurality pieces of recommended content).

Alternatively, or additionally, the ranking module 550 may also directly read, from the vector library 524, a set of recommendation system vectors 514 with similarities with the reference recommended content 540 reaching a threshold (or a predetermined number of recommended content with higher similarities). The ranking module 550 may determine a set of recommended content corresponding to the read set of recommendation system vectors 514 as a set of recommended content with similarities with the reference recommended content 540 reaching a threshold (or a predetermined number of recommended content with higher similarities). The set of candidate recommended content 570 may also include, for example, the set of recommended content.

In some embodiments, the set of candidate recommended content 570 may be directly determined as the third set of candidate recommended content 236. Alternatively, or additionally, in some embodiments, the screening module 226 may further include a second selecting module 580. The second selecting module 580 may perform secondary screening on the set of candidate recommended content 570 in combination with the first content screening strategy. In this case, referring to FIG. 3, a set of candidate recommended content 570 may be treated as content library 120 in FIG. 3. The set of candidate recommended content 570 includes recommended content that has been previously delivered. The second selecting module 580 may determine, from the feature data 516 and the label data 535, feature data and label data corresponding to the set of candidate recommended content 570, the feature data corresponding to the set of candidate recommended content 570 may correspond to the feature data 310 in FIG. 3, and the label data corresponding to the set of candidate recommended content 570 may correspond to the label data 302 in FIG. 3. The second selecting module 580 may select a set of candidate recommended content 590 from the set of candidate recommended content 570 based on the feature data and the label data corresponding to the set of candidate recommended content 570 and the predetermined recommendation metric, where the set of candidate recommended content 590 is the third set of candidate recommended content 236.

Regarding the training mode of the machine learning model, the machine learning model 250 may be trained at a device corresponding to the content delivery platform 110, or provided to the content delivery platform 110 after being trained at other devices. For ease of description, the electronic device for training the machine learning model 250 may be referred to as a model training system. The model training system may train the machine learning model using a training sample set, training samples in the training sample set include reference information of a plurality pieces of sample recommended content and sample user pairs, and a plurality of labels corresponding to the plurality pieces of sample recommended content, and each label indicates a labeling recommendation score of the corresponding sample recommended content relative to the corresponding sample user. For example, the annotation recommendation score may be one of the intervals [0, 1], and the closer to 1 the value corresponding to the annotation recommendation score is, the more likely the corresponding sample recommended content should be recommended to the sample user.

The model training system may provide the content reference information of the sample recommended content and the user reference information of the sample user to the untrained machine learning model 250, and the model output of the machine learning model 250 may indicate the estimated recommendation score of the sample recommended content with respect to the sample user. The model training system may determine a difference between the estimated recommendation score and the annotation recommendation score corresponding to each piece of sample recommended content. For example, the training target may be, for example, a difference between the estimated recommendation score corresponding to the plurality of sample recommended content and the annotation recommendation score being less than a threshold (for example, 0).

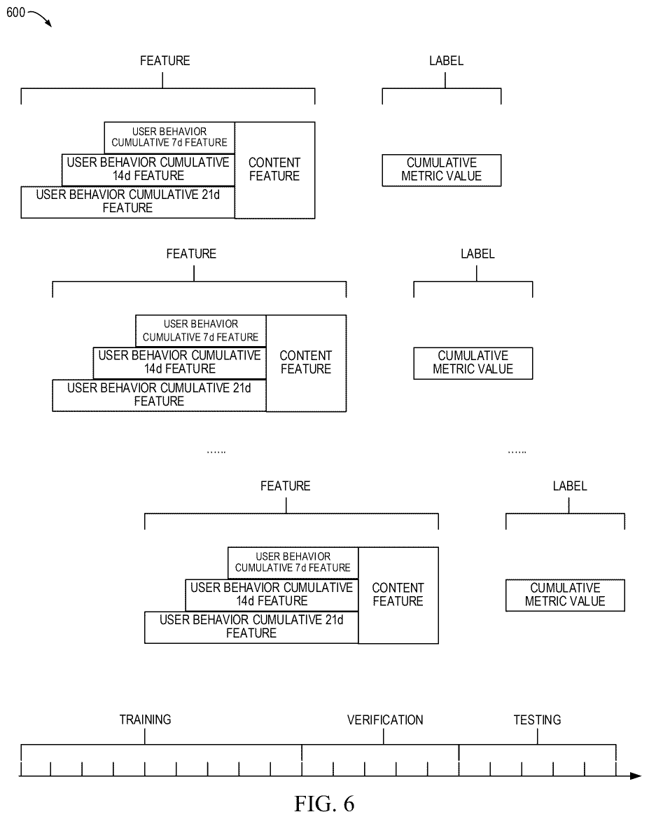

The training sample set may be obtained directly by the model training system, or automatically generated by the model training system according to an appropriate manner. In some embodiments, the model training system may obtain user behavior features, content features, and recommendation effects corresponding to a plurality pieces of recommended content that have been delivered (which may be considered as a plurality pieces of sample recommended content). FIG. 6 illustrates an example 600 of training data for a ranking model for a user, in accordance with some embodiments of the present disclosure. As shown in FIG. 6, the model training system may obtain a user behavior feature after each piece of sample recommended content is delivered and a content feature of each piece of sample recommended content (the two features may be collectively referred to as a feature). The user behavior feature of each piece of sample recommended content may be obtained periodically.

As an example, the model training system may obtain a sum of the user behavior features (that is, the user behavior feature cumulated by 7d in FIG. 6) of the sample recommended content for a period of time after the sample recommended content is recommended to the user (for example, 7 days), a sum of the user behavior features (that is, the user behavior feature cumulated by 14d in FIG. 6) after the sample recommended content is recommended to the user for a longer period of time (for example, 14 days), a sum of the user behavior features (that is, the user behavior feature cumulated by 21d in the figure) that the sample recommended content is recommended to the user for an even longer period of time (for example, 21 days), and the like. The model training system may further obtain a cumulative metric value (for example, a cumulative metric value after the sample recommended content is recommended) of the sample recommended content for the given recommendation metric after being recommended to the specific user, where the cumulative metric value may reflect the recommendation effect of the sample recommended content, the higher the cumulative metric value is, the better the recommendation effect is. The collected cumulative metric value may be referred to as a label for the sample recommended content and the user. If the accumulated metric value indicated by the label is higher, it means that the specific recommended content has a higher probability to be recommended to the corresponding user. Note that the specific collection of feature data here is by way of example only and does not imply any limitation. Other feature data may be configured as needed in practical applications.

Therefore, the model training system may obtain respective feature data and labels of sample recommended content and sample user pairs. The respective feature data of sample recommendation and sample user pairs may be regarded as content reference information of the sample recommended content and user reference information of the sample user. The model training system may construct a sample set based on the obtained respective feature data and labels of sample recommended content-sample user pairs. The model training system may, for example, directly consider this sample set as the training sample set and use it to train the machine learning model 250. Alternatively, or additionally, in some embodiments, the model training system may also divide the sample set into three non-overlapping portions, with a portion determined as a training sample set, a portion determined as a validation sample set, and a portion determined as a test sample set. The model training system may train the machine learning model 250 with the training sample set, validate the machine learning model 250 with the validation sample set and test the machine learning model 250 with the test sample set in turn.

After training, verification and testing are completed, the trained machine learning model 250 may be used to determine, based on the user reference information of the target user and the content reference information of the plurality of sets of candidate recommended content, a recommendation score of each of the plurality of sets of candidate recommended content relative to the target user.

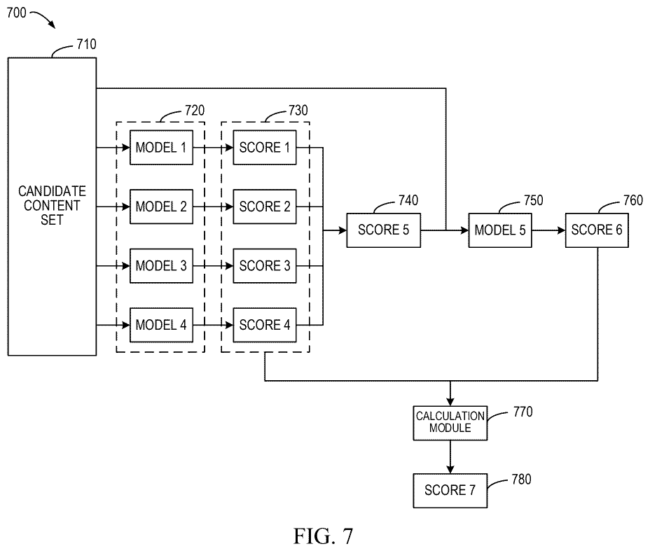

The content delivery platform 110 may obtain a trained machine learning model 250. A specific manner of determining the recommendation score of each piece of candidate recommended content with respect to the target user using the trained machine learning model 250 is described below with reference to FIG. 7. FIG. 7 shows an example 700 of determining a recommendation score of each piece of candidate recommended content with respect to a target user using the trained machine learning model 250 according to some embodiments of the present disclosure. In example 700, the machine learning model 250 includes a plurality of machine learning models (which may be referred to simply as models). In some embodiments, the plurality of sets of candidate recommended content obtained using the plurality of content screening strategies may be referred to as candidate content sets 710.

In some embodiments, the machine learning model 250 includes a plurality of first machine learning models 720 (which may include, for example, 4 first machine learning models from the model 1 to the model 4, and it may be understood that this is only an example, and it may actually include any number of first machine learning models). For each piece of candidate recommended content in the candidate content set 710, the content delivery platform 110 may respectively determine a first intermediate recommendation score of each piece of candidate recommended content using the plurality of first machine learning models 720, to obtain a plurality of first intermediate recommendation scores 730 (for example, the 4 first intermediate recommendation scores output by the 4 first machine learning models in the figure) of each piece of candidate recommended content.

The content delivery platform 110 may determine the recommendation score of each piece of candidate recommended content based on the plurality of first intermediate recommendation scores 730. In some embodiments, for each piece of candidate recommended content, the content delivery platform 110 may determine a target score (for example, the score 5740 shown in the figure) of the plurality of first intermediate recommendation scores 730 corresponding to the candidate recommended content. The target score may be an average score, a maximum score, a minimum score, or the like of the plurality of first intermediate scores 730, which is not limited in the present disclosure. For example, the content delivery platform 110 may determine the target score as the recommendation score corresponding to the candidate recommended content. The content delivery platform 110 may further determine the recommendation score of each piece of candidate recommended content in the candidate content set 710 in such a manner.

In some embodiments, the machine learning model 250 may further include a second machine learning model (the second machine learning model may also include at least one machine learning model, and the second machine learning model includes only the model 5750 as an example). The content delivery platform 110 may further determine a second intermediate recommendation score (for example, the score 6760 shown in the figure) of each piece of candidate recommended content based on the plurality of first intermediate recommendation scores (or the plurality of target scores of the plurality of first intermediate scores) and each of the plurality of sets of candidate recommended content using the second machine learning model. For example, the content delivery platform 110 may directly determine the second intermediate recommendation score of each piece of candidate recommended content as the recommendation score of each piece of candidate recommended content.

Alternatively, or additionally, in some embodiments, the content delivery platform 110 may further include a calculation module 770. The calculating module 770 may determine an average score (for example, the score 7780 in the figure) of the plurality of first intermediate recommendation scores and the second intermediate scores of the candidate recommended content. For example, the content delivery platform 110 may determine the average score of each piece of candidate recommended content as the recommendation score corresponding to each piece of candidate recommended content.

In summary, according to the embodiments of the present disclosure, the plurality of recommended content in the content library may be selected using a plurality of content screening strategies before the ranking, and then only some candidate recommended content selected by the model processing are used. The accuracy and efficiency of content recommendation may be improved, the limitation of the amount and type of recommended content included in the content library can be avoided, and the efficiency of recommended content processing may be further reduced.

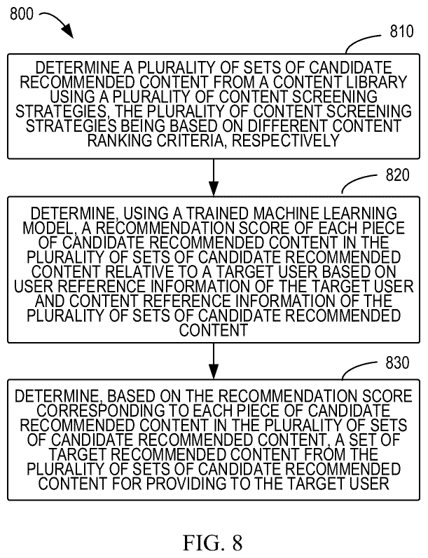

FIG. 8 shows a flowchart of a method 800 for content recommendation according to some embodiments of the present disclosure. The method 800 may be implemented at the content delivery platform 110. The method 800 will be described with reference to the environment 100 of FIG. 1.

In block 810, the content delivery platform 110 determines a plurality of sets of candidate recommended content from the content library using a plurality of content screening strategies, and the plurality of content screening strategies are based on different content ranking criteria, respectively.

At block 820, the content delivery platform 110 determines, based on user reference information of a target user and content reference information of the plurality of sets of candidate recommended content, a recommendation score of each piece of candidate recommended content in the plurality of sets of candidate recommended content relative to the target user using a trained machine learning model.

At block 830, the content delivery platform 110 determines a set of target recommended content from the plurality of sets of candidate recommended content based on the recommendation score corresponding to each piece of candidate recommended content in the plurality of sets of candidate recommended content for providing to the target user.

In some embodiments, determining the plurality of sets of candidate recommended content from the content library using the plurality of content screening strategies includes: for each of the plurality of content screening strategies, ranking the recommended content in the content library based on a content ranking criterion corresponding to the content screening strategy; and selecting a set of candidate recommended content in the content library based on the ranking result.

In some embodiments, determining the plurality of sets of candidate recommended content from the content library using the plurality of content screening strategies includes: for a first content screening strategy of the plurality of content screening strategies, determining at least one feature related to the predetermined recommendation metric; for each of the at least one feature, ranking the recommended content in the content library based on a feature value of each piece of recommended content in the content library for the feature; and selecting a first set of candidate recommended content from the content library based on a result of the ranking for the at least one feature.

In some embodiments, the at least one feature includes a plurality of features. In some embodiments, ranking the recommended content in the content library based on the feature value of each piece of the recommended content in the content library for each feature includes: dividing, according to a plurality of dividing dimensions, the recommended content in the content library into a plurality of content sub-libraries respectively corresponding to the plurality of dividing dimensions; for a given dividing dimension of the plurality of dividing dimensions, for each of the plurality of features, determining a metric value of the annotated recommended content under the predetermined recommendation metric, the annotated recommended content being divided into the given dividing dimension and related to the feature, and selecting a reference feature for the given dividing dimension from the plurality of features based on the differences between the metric values determined for the plurality of features and a reference metric value; and for each of the plurality of dividing dimensions, ranking, based on a feature value of the recommended content in the content sub-library corresponding to the dividing dimension for the corresponding reference feature, the recommended content in the content sub-library corresponding to the dividing dimension to obtain a ranking result for the plurality of dividing dimensions.

In some embodiments, determining the plurality of sets of candidate recommended content from the content library using the plurality of content screening strategies includes: for a second one of the plurality of content screening strategies, determining a set of features associated with a reference user; ranking the recommended content in the content library based on the feature value of each piece of recommended content in the content library for the set of features; and selecting a second set of candidate recommended content from the content library based on the result of the ranking.

In some embodiments, determining at least one feature associated with the reference user includes: for a plurality of dividing dimensions of the recommended content in the content library, determining a plurality of reference users respectively corresponding to the plurality of dividing dimensions; and determining a plurality of sets of features respectively associated with the plurality of reference users; and where the ranking the recommended content in the content library based on the feature values of each piece of recommended content in the content library for each feature of the set of features includes: dividing, according to a plurality of divided dimensions, the recommended content in the content library into a plurality of content sub-libraries respectively corresponding to the plurality of divided dimensions; and for a given one of the plurality of dividing dimensions, ranking, based on the feature values of the content sub-library corresponding to the given dividing dimension for a corresponding set of features, the recommended content in the content sub-library corresponding to the given dividing dimension.

In some embodiments, determining the plurality of sets of candidate recommended content from the content library using the plurality of content screening strategies includes: for a third content screening strategy of the plurality of content screening strategies, determining a plurality pieces of reference recommended content; for each of the plurality pieces of reference recommended content, ranking the recommended content in the content library based on a similarity between each piece of recommended content in the content library and the reference recommended content; and selecting a third set of candidate recommended content from the content library based on a result of the ranking for the plurality pieces of reference recommended content.

In some embodiments, the machine learning model includes a plurality of first machine learning models, and determining the recommendation score of each piece of candidate recommended content in the plurality of sets of candidate recommended content with respect to the target user includes: for each piece of candidate recommended content in the plurality of sets of candidate recommended content, determining a first intermediate recommendation score of each piece of candidate recommended content using a plurality of first machine learning models, to obtain a plurality of first intermediate recommendation scores of each piece of candidate recommended content; and determining the recommendation score of each piece of candidate recommended content based on the plurality of the first intermediate recommendation scores.

In some embodiments, the machine learning model further includes a second machine learning model, and the determining the recommendation score of each piece of candidate recommended content based on the plurality of first intermediate recommendation scores includes: determining, using the second machine learning model, a second intermediate recommendation score of each piece of candidate recommended content based on the plurality of first intermediate recommendation scores and each piece of candidate recommended content in the plurality of sets of candidate recommended content; and determining, based at least on the second intermediate recommendation score, the recommendation score of each piece of candidate recommended content.

In some embodiments, determining the recommendation score of each piece of candidate recommended content based at least on the second intermediate recommendation score includes: for each piece of candidate recommended content, determining a recommendation score of each piece of candidate recommended content based on the second intermediate recommendation score and the plurality of the first intermediate recommendation scores.

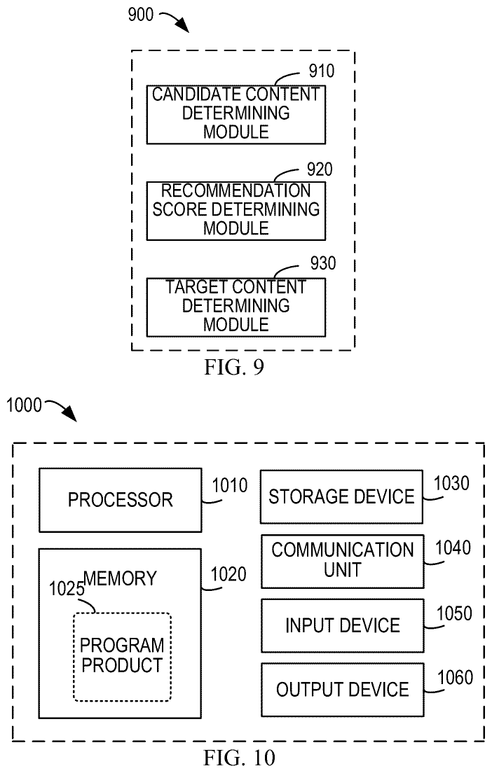

Embodiments of the present disclosure also provide a corresponding apparatus for implementing the above method or process. FIG. 9 illustrates an illustrative structural block diagram of an apparatus 900 for content recommendation according to some embodiments of the present disclosure. The apparatus 900 may be implemented or included in the content delivery platform 110. The various modules/components in the apparatus 900 may be implemented by hardware, software, firmware, or any combination thereof.

As shown in FIG. 9, the apparatus 900 includes a candidate content determining module 910 configured to determine a plurality of sets of candidate recommended content from a content library using a plurality of content screening strategies, where the plurality of content screening strategies is based on different content ranking criteria, respectively. The apparatus 900 further includes a recommendation score determining module 920, configured to determine, based on user reference information of a target user and content reference information of the plurality of sets of candidate recommended content, a recommendation score of each piece of candidate recommended content in the plurality of sets of candidate recommended content relative to the target user using a trained machine learning model. The apparatus 900 further includes a target content determining module 930, configured to determine a set of target recommended content from the plurality of sets of candidate recommended content based on a recommendation score corresponding to each piece of candidate recommended content in the plurality of sets of candidate recommended content, for providing to the target user.

In some embodiments, the candidate content determining module 910 is further configured to: for each of the plurality of content screening strategies, rank the recommended content in the content library based on a content ranking criterion corresponding to the content screening strategy; and select a set of candidate recommended content in the content library based on the ranking result.

In some embodiments, the candidate content determining module 910 is further configured to: for a first content filtering strategy of the plurality of content filtering strategies, determine at least one feature related to the predetermined recommendation metric; for each of the at least one feature, rank the recommended content in the content library based on a feature value of each piece of recommended content in the content library for the feature; and select the first set of candidate recommended content from the content library based on a result of the ranking for the at least one feature.

In some embodiments, the at least one feature includes a plurality of features, and the candidate content determination module 910 is further configured to: divide, according to a plurality of dividing dimensions, the recommended content in the content library into a plurality of content sub-libraries respectively corresponding to the plurality of dividing dimensions; for a given dividing dimension of the plurality of dividing dimensions, for each of plurality of features, determine a metric value of an annotated recommended content under a predetermined recommendation metric, where the annotated recommended content is divided into the given dividing dimension and related to the feature, and select a reference feature for the given dividing dimension from the plurality of features based on the differences between the metric values determined for the plurality of features and a reference metric value; and for each of the plurality of dividing dimensions, rank, based on a feature value of the recommended content in a content sub-library corresponding to the dividing dimension for a corresponding reference feature, the recommended content in the content sub-library corresponding to the dividing dimension to obtain a ranking result for the plurality of dividing dimensions.

In some embodiments, the candidate content determining module 910 is further configured to: for a second content screening strategy of the plurality of content filtering strategies, determine a set of features associated with a reference user; rank the recommended content in the content library based on the feature value of each piece of recommended content in the content library for the set of features; and select a second set of candidate recommended content from the content library based on the result of the ranking.

In some embodiments, the candidate content determining module 910 is further configured to: determine, for a plurality of dividing dimensions of the recommended content in the content library, a plurality of reference users respectively corresponding to the plurality of dividing dimensions; and determine a plurality of sets of features respectively associated with the plurality of reference users; and where the ranking the recommended content in the content library based on the feature value of each piece of recommended content in the content library for each feature of the set of features comprises: dividing, according to a plurality of dividing dimensions, the recommended content in the content library into a plurality of content sub-libraries respectively corresponding to the plurality of dividing dimensions; and rank, for a given dividing dimension of the plurality of dividing dimensions, the recommended content in the content sub-library corresponding to the given dividing dimension based on feature values of the content sub-library corresponding to the given dividing dimension on the corresponding set of features.

In some embodiments, the candidate content determining module 910 is further configured to: determine a plurality pieces of reference recommended content for a third content screening strategy of the plurality of content screening strategies; for each piece of reference recommended content in the plurality pieces of reference recommended content, rank the recommended content in the content library based on a similarity between each piece of recommended content in the content library and the reference recommended content; and select a third set of candidate recommended content from the content library based on a result of the ranking for the plurality pieces of reference recommended content.

In some embodiments, the machine learning model includes a plurality of first machine learning models, and the recommendation score determining module 920 is further configured to: for each piece of candidate recommended content in the plurality of sets of candidate recommended content, determine, using the plurality of first machine learning models, a first intermediate recommendation score of each piece of candidate recommended content to obtain a plurality of first intermediate recommendation scores of each piece of candidate recommended content; and determine a recommendation score of each piece of candidate recommended content based on the plurality of the first intermediate recommendation scores.

In some embodiments, the machine learning model further includes a second machine learning model, and the recommendation score determining module 920 is further configured to: determine, using the second machine learning model, a second intermediate recommendation score of each piece of candidate recommended content based on the plurality of first intermediate recommendation scores and each piece of candidate recommended content in the plurality of sets of candidate recommended content; and determine, based at least on the second intermediate recommendation score, a recommendation score of each piece of candidate recommended content.

In some embodiments, the recommendation score determination module 920 is further configured to: for each piece of candidate recommended content, determine a recommendation score of each piece of candidate recommended content based on the second intermediate recommendation score and the plurality of the first intermediate recommendation scores.

The units and/or modules included in the apparatus 900 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 900 may be implemented, at least in part, by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more of the above methods may be performed by a suitable electronic device or a combination of electronic devices. Such electronic devices or combinations of electronic devices may include, for example, content delivery platform 110 in FIG. 1.

FIG. 10 illustrates a block diagram of an electronic device 1000 in which one or more embodiments of the present disclosure may be implemented. It should be understood that the electronic device 1000 illustrated in FIG. 10 is merely illustrative and should not constitute any limitation on the functionality and scope of the embodiments described herein. The electronic device 1000 shown in FIG. 10 may be configured to implement the content delivery platform 110 of FIG. 1 and/or the apparatus 900 of FIG. 9.

As shown in FIG. 10, the electronic device 1000 is in the form of a general-purpose electronic device. Components of the electronic device 1000 may include, but are not limited to, one or more processors or processing units 1010, a memory 1020, a storage device 1030, one or more communication units 1040, one or more input devices 1050, and one or more output devices 1060. The processor 1010 may be an actual or virtual processor and capable of performing various processes according to programs stored in the memory 1020. In multiprocessor systems, multiple processors execute computer-executable instructions in parallel to improve parallel processing capabilities of electronic device 1000.

Electronic device 1000 typically includes a plurality of computer storage media. Such media may be any available media accessible to the electronic device 1000, including, but not limited to, volatile and non-volatile media, removable and non-removable media. The memory 1020 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1030 may be a removable or non-removable medium and may include a machine-readable medium, such as a flash drive, magnetic disk, or any other medium, which may be capable of storing information and/or data and may be accessed within electronic device 1000.

The electronic device 1000 may further include additional removable/non-removable, volatile/non-volatile storage media. Although not shown in FIG. 10, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1020 may include a computer program product 1025 having one or more program modules configured to perform various methods or actions of various embodiments of the present disclosure.

The communication unit 1040 is configured to communicate with another electronic device through a communication medium. Additionally, the functionality of components of the electronic device 1000 may be implemented in a single computing cluster or multiple computing machines capable of communicating over a communication connection. Thus, the electronic device 1000 may operate in a networked environment using logical connections with one or more other servers, network personal computers (PCs), or another network node.

The input device 1050 may be one or more input devices such as a mouse, a keyboard, a trackball, or the like. The output device 1060 may be one or more output devices, such as a display, a speaker, a printer, or the like. The electronic device 1000 may also communicate with one or more external devices (not shown) through the communication unit 1040 as needed, external devices such as storage devices, display devices, etc., communicate with one or more devices that enable a user to interact with the electronic device 1000, or communicate with any device (e.g., a network card, a modem, etc.) that enables the electronic device 1000 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general-purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

I/We claim:

1. A method for content recommendation, comprising:
determining a plurality of sets of candidate recommended content from a content library using a plurality of content screening strategies, the plurality of content screening strategies being based on different content ranking criteria, respectively;
determining, using a trained machine learning model, a recommendation score of each piece of candidate recommended content in the plurality of sets of candidate recommended content relative to a target user based on user reference information of the target user and content reference information of the plurality of sets of candidate recommended content; and
determining, based on the recommendation score corresponding to each piece of candidate recommended content in the plurality of sets of candidate recommended content, a set of target recommended content from the plurality of sets of candidate recommended content for providing to the target user.

2. The method of claim 1, wherein determining the plurality of sets of candidate recommended content from the content library using the plurality of content screening strategies comprises:
for each of the plurality of content screening strategies,
ranking recommended content in the content library based on a content ranking criterion corresponding to the content screening strategy; and
selecting a set of candidate recommended content in the content library based on the ranking result.

3. The method of claim 1, wherein determining the plurality of sets of candidate recommended content from the content library using the plurality of content screening strategies comprises: for a first content screening strategy of the plurality of content screening strategies,
determining at least one feature related to a predetermined recommendation metric;
for each of the at least one feature, ranking recommended content in the content library based on a feature value of each piece of recommended content in the content library for the feature; and
selecting a first set of candidate recommended content from the content library based on a result of the ranking for the at least one feature.

4. The method of claim 3, wherein the at least one feature comprises a plurality of features, and ranking the recommended content in the content library based on the feature value of each piece of recommended content in the content library for each feature comprises:
dividing, according to a plurality of dividing dimensions, the recommended content in the content library into a plurality of content sub-libraries respectively corresponding to the plurality of dividing dimensions;
for a given dividing dimension of the plurality of dividing dimensions,
for each of the plurality of features, determining a metric value of an annotated recommended content under the predetermined recommendation metric, the annotated recommended content being divided into the given dividing dimension and related to the feature, and
selecting a reference feature for the given dividing dimension from the plurality of features based on the differences between metric values determined for the plurality of features and a reference metric value; and
for each of the plurality of dividing dimensions, ranking, based on a feature value of the recommended content in a content sub-library corresponding to the dividing dimension for a corresponding reference feature, the recommended content in the content sub-library corresponding to the dividing dimension, to obtain a ranking result for the plurality of dividing dimensions.

5. The method of claim 1, wherein determining the plurality of sets of candidate recommended content from the content library using the plurality of content screening strategies comprises: for a second content screening strategy of the plurality of content screening strategies,
determining a set of features associated with a reference user;
ranking the recommended content in the content library based on the feature value of each piece of recommended content in the content library for the set of features; and
selecting a second set of candidate recommended content from the content library based on a result of the ranking.

6. The method of claim 5, wherein determining the set of features associated with the reference user comprises:
for a plurality of dividing dimensions for the recommended content in the content library,
determining a plurality of reference users corresponding to the plurality of dividing dimensions; and
determining a plurality of sets of features respectively associated with the plurality of reference users; and
wherein the ranking the recommended content in the content library based on the feature value of each piece of recommended content in the content library for each feature of the set of features includes:
dividing, according to a plurality of dividing dimensions, the recommended content in the content library into a plurality of content sub-libraries respectively corresponding to the plurality of dividing dimensions; and
for a given dividing dimension of the plurality of dividing dimensions, ranking, based on feature values of the content sub-library corresponding to the given dividing dimension for a corresponding set of features, the recommended content in the content sub-library corresponding to the given dividing dimension.

7. The method of claim 1, wherein determining the plurality of sets of candidate recommended content from the content library using the plurality of content screening strategies comprises: for a third content screening strategy of the plurality of content screening strategies,
determining a plurality pieces of reference recommended content;
for each piece of reference recommended content in the plurality pieces of reference recommended content, ranking the recommended content in the content library based on a similarity between each piece of recommended content in the content library and the reference recommended content; and
selecting a third set of candidate recommended content from the content library based on a result of the ranking for the plurality pieces of reference recommended content.

8. The method of claim 1, wherein the machine learning model comprises a plurality of first machine learning models, and wherein determining the recommendation score of each piece of candidate recommended content in the plurality of sets of candidate recommended content relative to the target user comprises:
for each piece of candidate recommended content in the plurality of sets of candidate recommended content,
determining, using the plurality of first machine learning models, a first intermediate recommendation score of each piece of candidate recommended content to obtain a plurality of first intermediate recommendation scores of each piece of candidate recommended content; and
determining the recommendation score of each piece of candidate recommended content based on the plurality of the first intermediate recommendation scores.

9. The method of claim 8, wherein the machine learning model further comprises a second machine learning model, and wherein determining the recommendation score of each piece of candidate recommended content based on the plurality of the first intermediate recommendation scores comprises:
determining, using the second machine learning model, a second intermediate recommendation score of each piece of candidate recommended content based on the plurality of first intermediate recommendation scores and each piece of candidate recommended content in the plurality of sets of candidate recommended content; and
determining the recommendation score of each piece of candidate recommended content based at least on the second intermediate recommendation score.

10. The method of claim 9, wherein determining the recommendation score of each piece of candidate recommended content based at least on the second intermediate recommendation score comprises:
for each piece of candidate recommended content, determining the recommendation score of each piece of candidate recommended content based on the second intermediate recommendation score and the plurality of the first intermediate recommendation scores.

11. An electronic device, comprising:
at least one processor; and
at least one memory coupled to the at least one processor and storing instructions for execution by the at least one processor, the instructions, when executed by the at least one processor, causing the electronic device to perform a method for content recommendation, comprising:
determining a plurality of sets of candidate recommended content from a content library using a plurality of content screening strategies, the plurality of content screening strategies being based on different content ranking criteria, respectively;
determining, using a trained machine learning model, a recommendation score of each piece of candidate recommended content in the plurality of sets of candidate recommended content relative to a target user based on user reference information of the target user and content reference information of the plurality of sets of candidate recommended content; and
determining, based on the recommendation score corresponding to each piece of candidate recommended content in the plurality of sets of candidate recommended content, a set of target recommended content from the plurality of sets of candidate recommended content for providing to the target user.

12. The electronic device of claim 11, wherein determining the plurality of sets of candidate recommended content from the content library using the plurality of content screening strategies comprises:
for each of the plurality of content screening strategies,
ranking recommended content in the content library based on a content ranking criterion corresponding to the content screening strategy; and
selecting a set of candidate recommended content in the content library based on the ranking result.

13. The electronic device of claim 11, wherein determining the plurality of sets of candidate recommended content from the content library using the plurality of content screening strategies comprises: for a first content screening strategy of the plurality of content screening strategies,
determining at least one feature related to a predetermined recommendation metric;
for each of the at least one feature, ranking recommended content in the content library based on a feature value of each piece of recommended content in the content library for the feature; and
selecting a first set of candidate recommended content from the content library based on a result of the ranking for the at least one feature.

14. The electronic device of claim 13, wherein the at least one feature comprises a plurality of features, and ranking the recommended content in the content library based on the feature value of each piece of recommended content in the content library for each feature comprises:
dividing, according to a plurality of dividing dimensions, the recommended content in the content library into a plurality of content sub-libraries respectively corresponding to the plurality of dividing dimensions;
for a given dividing dimension of the plurality of dividing dimensions,
for each of the plurality of features, determining a metric value of an annotated recommended content under the predetermined recommendation metric, the annotated recommended content being divided into the given dividing dimension and related to the feature, and
selecting a reference feature for the given dividing dimension from the plurality of features based on the differences between metric values determined for the plurality of features and a reference metric value; and
for each of the plurality of dividing dimensions, ranking, based on a feature value of the recommended content in a content sub-library corresponding to the dividing dimension for a corresponding reference feature, the recommended content in the content sub-library corresponding to the dividing dimension, to obtain a ranking result for the plurality of dividing dimensions.

15. The electronic device of claim 11, wherein determining the plurality of sets of candidate recommended content from the content library using the plurality of content screening strategies comprises: for a second content screening strategy of the plurality of content screening strategies,
determining a set of features associated with a reference user;
ranking the recommended content in the content library based on the feature value of each piece of recommended content in the content library for the set of features; and
selecting a second set of candidate recommended content from the content library based on a result of the ranking.

16. The electronic device of claim 15, wherein determining the set of features associated with the reference user comprises:
for a plurality of dividing dimensions for the recommended content in the content library,
determining a plurality of reference users corresponding to the plurality of dividing dimensions; and
determining a plurality of sets of features respectively associated with the plurality of reference users; and
wherein the ranking the recommended content in the content library based on the feature value of each piece of recommended content in the content library for each feature of the set of features includes:
dividing, according to a plurality of dividing dimensions, the recommended content in the content library into a plurality of content sub-libraries respectively corresponding to the plurality of dividing dimensions; and
for a given dividing dimension of the plurality of dividing dimensions, ranking, based on feature values of the content sub-library corresponding to the given dividing dimension for a corresponding set of features, the recommended content in the content sub-library corresponding to the given dividing dimension.

17. The electronic device of claim 11, wherein determining the plurality of sets of candidate recommended content from the content library using the plurality of content screening strategies comprises: for a third content screening strategy of the plurality of content screening strategies,
determining a plurality pieces of reference recommended content;
for each piece of reference recommended content in the plurality pieces of reference recommended content, ranking the recommended content in the content library based on a similarity between each piece of recommended content in the content library and the reference recommended content; and
selecting a third set of candidate recommended content from the content library based on a result of the ranking for the plurality pieces of reference recommended content.

18. The electronic device of claim 11, wherein the machine learning model comprises a plurality of first machine learning models, and wherein determining the recommendation score of each piece of candidate recommended content in the plurality of sets of candidate recommended content relative to the target user comprises:
for each piece of candidate recommended content in the plurality of sets of candidate recommended content,
determining, using the plurality of first machine learning models, a first intermediate recommendation score of each piece of candidate recommended content to obtain a plurality of first intermediate recommendation scores of each piece of candidate recommended content; and
determining the recommendation score of each piece of candidate recommended content based on the plurality of the first intermediate recommendation scores.

19. The electronic device of claim 18, wherein the machine learning model further comprises a second machine learning model, and wherein determining the recommendation score of each piece of candidate recommended content based on the plurality of the first intermediate recommendation scores comprises:
determining, using the second machine learning model, a second intermediate recommendation score of each piece of candidate recommended content based on the plurality of first intermediate recommendation scores and each piece of candidate recommended content in the plurality of sets of candidate recommended content; and
determining the recommendation score of each piece of candidate recommended content based at least on the second intermediate recommendation score.

20. A non-transitory computer readable storage medium with a computer program stored thereon, wherein the computer program, when executed by a processor, implements a method for content recommendation, comprising:
determining a plurality of sets of candidate recommended content from a content library using a plurality of content screening strategies, the plurality of content screening strategies being based on different content ranking criteria, respectively;
determining, using a trained machine learning model, a recommendation score of each piece of candidate recommended content in the plurality of sets of candidate recommended content relative to a target user based on user reference information of the target user and content reference information of the plurality of sets of candidate recommended content; and
determining, based on the recommendation score corresponding to each piece of candidate recommended content in the plurality of sets of candidate recommended content, a set of target recommended content from the plurality of sets of candidate recommended content for providing to the target user.
